(19) United States
(12) Patent Application Publication
(10) Pub. No.: US 2022/0032335 A1
(43) Pub. Date: Feb. 3, 2022

(54) LIQUID COATING APPARATUS

(71) Applicant: NIDEC MACHINERY CORPORATION, Tottori (JP)

(72) Inventors: Pengtuan LI, Kyoto (JP); Masaji NAKATANI, Kyoto (JP); Akira ISHITANI, Tottori (JP); Yasushi NAKAMURA, Tottori (JP); Akihiro NISHIMURA, Tottori (JP)

(21) Appl. No.: 17/279,660

(22) PCT Filed: Aug. 28, 2019
(86) PCT No.: PCT/JP2019/033695

§ 371 Date: Mar. 25, 2021

(30) Foreign Application Priority Data
Sep. 26, 2018 (JP) 2018-180759

(51) Int. Cl. B05C 5/02; B05C 5/00

(52) U.S. Cl. CPC B05C 5/0225; B05C 5/001

(57) ABSTRACT

A liquid coating apparatus includes a liquid storage assembly to store a liquid, a pressure sensor to detect a remaining amount of liquid in the liquid storage assembly, a discharge assembly to discharge the liquid in the liquid storage assembly to an outside, a negative pressure pump to generate a negative pressure lower than an atmospheric pressure, a negative pressure adjusting container with an internal pressure adjusted to a predetermined negative pressure by the negative pressure pump, a pressure adjustment controller to control drive of the negative pressure pump based on a detection result of the pressure sensor, and a pressure switch to adjust pressure in the liquid storage assembly to the predetermined negative pressure in the negative pressure adjusting container.

### CROSS REFERENCE TO RELATED APPLICATIONS

This is a U.S. national stage of PCT Application No. PCT/JP2019/033695, filed on Aug. 28, 2019, and claiming priority under 35 U.S.C. § 119(a) and 35 U.S.C. § 365(b) from Japanese Patent Application No. 2018-180759, filed on Sep. 26, 2018, the entire disclosures of each being hereby incorporated herein by reference.

### 1. FIELD OF THE INVENTION

The present disclosure relates to a liquid coating apparatus.

### 2. BACKGROUND

A liquid coating apparatus is known in which a liquid supplied from a liquid storage assembly is discharged to a material to be coated. Such a liquid coating apparatus changes the volume of a liquid chamber to discharge a liquid in the liquid chamber in many cases. As an example of the liquid coating apparatus, the volume of a liquid chamber containing a liquid may be changed using a flexible plate that is deformed by driving a piezoelectric element, thereby discharging the liquid through a nozzle.

Structure in which a liquid in a liquid chamber is discharged through a nozzle in a typical liquid coating apparatus may cause leakage of the liquid through the nozzle other than timing of discharging the liquid through the nozzle. Thus, a structure is considered in which a negative pressure regulator, such as a negative pressure pump, applies negative pressure to a liquid storage assembly that supplies a liquid into a liquid chamber, thereby preventing the liquid from leaking through a nozzle.

Unfortunately, the structure in which the negative pressure regulator applies negative pressure to the liquid in the liquid storage assembly requires time to allow the pressure in the liquid storage assembly to reach predetermined negative pressure. This may cause leakage of the liquid through the nozzle until the pressure in the liquid storage assembly reaches the predetermined negative pressure. In contrast, when the negative pressure in the liquid storage assembly is higher than the predetermined negative pressure, air may enter the liquid chamber when the liquid is drawn into the liquid chamber through the nozzle.

Further, when negative pressure is generated by a negative pressure regulator such as a negative pressure pump, pressure pulsation is generated by the negative pressure regulator. This causes negative pressure in the liquid storage assembly to fluctuate and requires time to stabilize the pressure in the liquid storage assembly.

### SUMMARY

A liquid coating apparatus according to an example embodiment of the present disclosure includes a liquid storage assembly to store a liquid, a liquid remaining amount detector to detect a remaining amount of liquid in the liquid storage assembly, a discharge assembly to discharge the liquid in the liquid storage assembly to an outside, a negative pressure generator to generate a negative pressure lower than an atmospheric pressure, a negative pressure adjusting container with an internal pressure adjusted to a predetermined negative pressure by the negative pressure generator, a negative pressure generation controller to control drive of the negative pressure generator based on a detection result of the liquid remaining amount detector, and a pressure switch to adjust pressure in the liquid storage assembly to the predetermined negative pressure in the negative pressure adjusting container.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a diagram illustrating a schematic configuration of a liquid coating apparatus according to an example embodiment of the present disclosure.

FIG. 2 is an enlarged view illustrating schematic structure of a discharge assembly according to an example embodiment of the present disclosure.

FIG. 3 is a flowchart illustrating an example of operation of a liquid coating apparatus according to an example embodiment of the present disclosure.

FIG. 4 is a diagram of a liquid coating apparatus according to another example embodiment of the present disclosure, corresponding to FIG. 1.

### DETAILED DESCRIPTION

Hereinafter, example embodiments of the present disclosure will be described in detail with reference to the drawings. The same or corresponding parts in the drawings are designated by the same reference numerals, and description thereof will not be duplicated. Each of the drawings shows dimensions of components that do not faithfully represent actual dimensions of the components and dimensional ratios of the respective components.

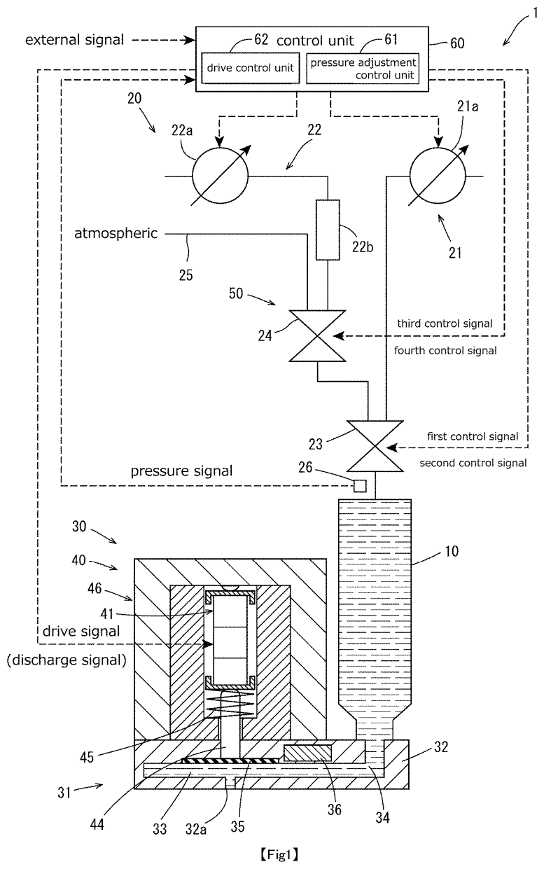

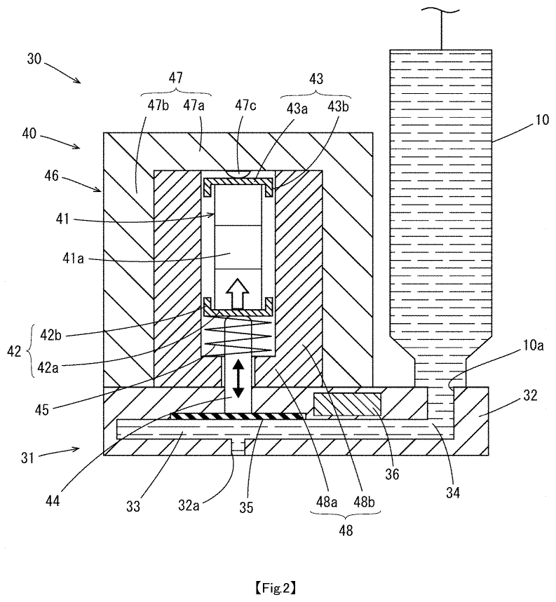

FIG. 1 is a diagram schematically illustrating a schematic configuration of a liquid coating apparatus 1 according to an example embodiment of the present disclosure. FIG. 2 is a flowchart illustrating operation of the liquid coating apparatus 1.

The liquid coating apparatus 1 is an ink-jet liquid coating apparatus that discharges a liquid in the form of droplets to the outside. Examples of the liquid include solder, thermosetting resin, ink, a coating liquid for forming a functional thin film such as an alignment film, a resist, a color filter, and organic electroluminescence, and the like.

The liquid coating apparatus 1 includes a liquid storage assembly 10, a pressure adjusting unit 20, a discharge assembly 30, and a controller 60.

The liquid storage assembly 10 is a container for storing a liquid inside. The liquid storage assembly 10 supplies the stored liquid to the discharge assembly 30. That is, the liquid storage assembly 10 includes an outlet 10a for supplying the stored liquid to the discharge assembly 30. Pressure in the liquid storage assembly 10 is adjusted by the pressure adjusting unit 20. The liquid storage assembly 10 includes a supply port (not illustrated) through which a liquid is supplied thereto.

The pressure adjusting unit 20 adjusts the pressure in the liquid storage assembly 10 to any one of positive pressure higher than an atmospheric pressure, negative pressure lower than the atmospheric pressure, and the atmospheric pressure. When the pressure in the liquid storage assembly 10 is adjusted in this way, as described later, a liquid can be stably discharged from a discharge port 32a of the discharge assembly 30, and the liquid can be prevented from leaking from the discharge port 32a.

Specifically, the pressure adjusting unit 20 includes a positive pressure generator 21, a negative pressure generator 22, a pressure switching assembly 50, an atmospheric opening unit 25, and a pressure sensor 26.

The positive pressure generator 21 generates positive pressure higher than the atmospheric pressure. The positive pressure generator 21 includes a positive pressure pump 21a. The positive pressure pump 21a is a positive pressure generator that generates positive pressure higher than the atmospheric pressure.

The negative pressure generator 22 generates negative pressure lower than the atmospheric pressure. The negative pressure generator 22 includes a negative pressure pump 22a and a negative pressure adjusting container 22b.

The negative pressure pump 22a is a negative pressure generator that generates negative pressure lower than the atmospheric pressure. Pressure inside the negative pressure adjusting container 22b becomes the negative pressure generated by the negative pressure pump 22a. The negative pressure adjusting container 22b is located between the negative pressure pump 22a and a second switching valve 24. When the negative pressure generator 22 includes the negative pressure adjusting container 22b, the negative pressure generated by the negative pressure pump 22a is uniformed to predetermined negative pressure.

This enables not only reducing pulsation of the negative pressure generated by the negative pressure pump 22a, but also acquiring stable predetermined negative pressure in the negative pressure generator 22. As described later, even when output of the negative pressure pump 22a changes in accordance with a detection result of pressure in the liquid storage assembly 10 acquired by the pressure sensor 26, the negative pressure adjusting container 22b reduces pulsation of negative pressure generated by the negative pressure pump 22a, and uniform predetermined negative pressure can be acquired under the negative pressure having changed. Thus, when the negative pressure generator 22 is connected to the liquid storage assembly 10 as described later, pressure in the liquid storage assembly 10 can be quickly set to the predetermined negative pressure.

The pressure switching assembly 50 switches pressure in the liquid storage assembly 10. Specifically, the pressure switching assembly 50 switches the pressure in the liquid storage assembly 10 among the positive pressure generated by the positive pressure generator 21, the predetermined negative pressure in the negative pressure adjusting container 22b, and the atmospheric pressure. That is, the pressure switching assembly 50 of the present example embodiment can switch the pressure in the liquid storage assembly 10 to the predetermined negative pressure in the negative pressure adjusting container 22b by using a first switching valve 23 and the second switching valve 24.

Specifically, the pressure switching assembly 50 includes the first switching valve 23 and the second switching valve 24, and switches the pressure in the liquid storage assembly 10 using the first switching valve 23 and the second switching valve 24.

The first switching valve 23 and the second switching valve 24 are each a three-way valve. That is, the first switching valve 23 and the second switching valve 24 each have three ports. The first switching valve 23 includes the three ports that are each connected to the corresponding one of the liquid storage assembly 10, the positive pressure generator 21, and the second switching valve 24. The second switching valve 24 includes the three ports that are each connected to the corresponding one of the negative pressure generator 22, the atmospheric opening unit 25, and the first switching valve 23.

The first switching valve 23 and the second switching valve 24 each allow two ports of the corresponding three ports to be internally connected to each other. In the present example embodiment, the first switching valve 23 allows the port connected to the liquid storage assembly 10 to be connected to the port connected to the positive pressure generator 21 or the port connected to the second switching valve 24. That is, the first switching valve 23 switches between a line connected to the positive pressure generator 21 and a line connected to the second switching valve 24 to connect the switched line to the liquid storage assembly 10. The second switching valve 24 allows the port connected to the first switching valve 23 to be connected to the port connected to the negative pressure generator 22 or the port connected to the atmospheric opening unit 25. That is, the second switching valve 24 switches between a line connected to the negative pressure generator 22 and a line connected to the atmospheric opening unit 25 to connect the switched line to the first switching valve 23.

The first switching valve 23 and the second switching valve 24 each switch connection between the corresponding ports in response to an open-close signal output from the controller 60. The open-close signal includes a first control signal, a second control signal, a third control signal, and a fourth control signal, which are described later.

The pressure sensor 26 detects pressure in the liquid storage assembly 10. The pressure sensor 26 outputs the detected pressure in the liquid storage assembly 10 as a pressure signal to the controller 60. Negative pressure to be detected by the pressure sensor 26 changes in accordance with a remaining amount of liquid in the liquid storage assembly 10. That is, when the remaining amount of liquid in the liquid storage assembly 10 decreases, the negative pressure detected by the pressure sensor 26 increases more than when a large amount of liquid remains. The increase in negative pressure means, for example, a state in which the negative pressure has changed from −1 kPa to −1.1 kPa.

In this way, the pressure sensor 26 detects the remaining amount of liquid in the liquid storage assembly 10 as pressure in the liquid storage assembly 10. That is, the pressure sensor 26 is a liquid remaining amount detector that detects the remaining amount of liquid in the liquid storage assembly 10. This enables the remaining amount of liquid in the liquid storage assembly 10 to be detected as pressure in the liquid storage assembly 10, and the controller 60 described later to control drive of the negative pressure pump 22a by using the detected pressure.

The controller 60 described later controls the drive of the negative pressure pump 22a in response to a pressure signal output from the pressure sensor 26. When decrease in the remaining amount of liquid in the liquid storage assembly 10 is detected by the pressure sensor 26 as high negative pressure in the liquid storage assembly 10, the controller 60 sets a negative pressure target value lower to bring negative pressure generated by the negative pressure pump 22a close to the atmospheric pressure.

The above configuration causes the pressure adjusting unit 20 to switch the first switching valve 23 to connect the positive pressure generator 21 to the liquid storage assembly 10 when pressure in the liquid storage assembly 10 is made positive, i.e., when the pressure in the liquid storage assembly 10 is pressurized to positive pressure. This enables a liquid to be pushed out from the liquid storage assembly 10 to the discharge assembly 30. Thus, the liquid can be stably supplied to the discharge assembly 30.

When the pressure in the liquid storage assembly 10 is made negative, the pressure adjusting unit 20 switches not only the second switching valve 24 to connect the negative pressure generator 22 to the first switching valve 23, but also the first switching valve 23 to connect the second switching valve 24 to the liquid storage assembly 10. This enables the liquid to be prevented from leaking from the discharge port 32a of the discharge assembly 30 by setting the pressure in the liquid storage assembly 10 to the predetermined negative pressure in the negative pressure adjusting container 22b.

When the pressure in the liquid storage assembly 10 is set to the atmospheric pressure, the pressure adjusting unit 20 switches the second switching valve 24 to connect the atmospheric opening unit 25 to the first switching valve 23. At this time, the first switching valve 23 is in a state in which the second switching valve 24 is connected to the liquid storage assembly 10. This enables the pressure in the liquid storage assembly 10 to be set to the atmospheric pressure.

As described above, the first switching valve 23 switches the pressure in the liquid storage assembly 10 between the positive pressure generated by the positive pressure generator and pressure other than the positive pressure. The second switching valve 24 switches between the atmospheric pressure and the predetermined negative pressure in the negative pressure adjusting container 22b as the pressure other than the positive pressure.

That is, the pressure switching assembly 50 includes the first switching valve 23 that switches the pressure in the liquid storage assembly 10 between the positive pressure generated by the positive pressure generator 21 and the pressure other than the positive pressure, and the second switching valve 24 that switches between the atmospheric pressure and the negative pressure in the negative pressure adjusting container 22b as the pressure other than the positive pressure. The first switching valve 23 is a first pressure switching assembly. The second switching valve 24 is a second pressure switching valve.

This enables the pressure in the liquid storage assembly 10 to be switched among the positive pressure generated by the positive pressure generator 21, the predetermined negative pressure in the negative pressure adjusting container 22b, and the atmospheric pressure. The two switching valves can switch the pressure in the liquid storage assembly 10 to any one of the three pressures, so that the pressure in the liquid storage assembly 10 can be switched with a small number of parts. This enables the liquid coating apparatus 1 to be fabricated with a simple and low-cost configuration.

The discharge assembly 30 discharges the liquid supplied from the liquid storage assembly 10 to the outside in the form of droplets. FIG. 2 is an enlarged view illustrating structure of the discharge assembly 30. Hereinafter, the structure of the discharge assembly 30 will be described with reference to FIG. 2.

The discharge assembly 30 includes a liquid supply unit 31, a diaphragm 35, and a drive 40.

The liquid supply unit 31 includes a base member 32 provided inside with a liquid chamber 33 and an inflow path 34, and a heating unit 36. The liquid storage assembly 10 is located on the base member 32. The inflow path 34 of the base member 32 is connected to an outlet 10a of the liquid storage assembly 10. The inflow path 34 is connected to the liquid chamber 33. That is, the inflow path 34 is connected to the liquid chamber 33 and allows the liquid to be supplied from the liquid storage assembly 10 into the liquid chamber 33. The liquid chamber 33 stores the liquid.

The base member 32 includes the discharge port 32a connected to the liquid chamber 33. The discharge port 32a is an opening for discharging the liquid supplied into the liquid chamber to the outside. In the present example embodiment, the discharge port 32a opens downward, so that the liquid supplied into the inflow path 34 and the liquid chamber 33 has a liquid level protruding downward caused by a meniscus in the discharge port 32a.

The heating unit 36 is located near the inflow path 34 in the base member 32. The heating unit 36 heats the liquid in the inflow path 34. Although not particularly illustrated, the heating unit 36 includes, for example, a plate-shaped heater and a heat transfer block. The heating unit 36 may include another component such as a rod-shaped heater or a Peltier element as long as it can heat the liquid in the inflow path.

Heating the fluid in the inflow path 34 with the heating unit 36 enables temperature of the liquid to be maintained at a constant temperature higher than room temperature. This enables preventing physical characteristics of the liquid from changing with temperature.

Although not particularly illustrated, the liquid coating apparatus 1 may include a temperature sensor for controlling heating of the heating unit 36, being located near the heating unit 36 or near the discharge port 32a. The heating unit 36 may be located on the base member 32 as long as the fluid in the inflow path 34 can be heated.

The diaphragm 35 constitutes a part of a wall portion defining the liquid chamber 33. The diaphragm 35 is located opposite to the discharge port 32a across the liquid chamber 33. The diaphragm 35 is supported by the base member 32 in a deformable manner in its thickness direction. The diaphragm 35 constitutes the part of the wall portion defining the liquid chamber 33, and is deformed to change the volume of the liquid chamber 33. When the diaphragm 35 is deformed in the thickness direction to change the volume of the liquid chamber 33, the liquid in the liquid chamber 33 is discharged to the outside through the discharge port 32a.

The drive 40 deforms the diaphragm 35 in the thickness direction. Specifically, the drive 40 includes a piezoelectric element 41, a first base 42, a second base 43, a plunger 44, a coil spring 45, and a casing 46.

The piezoelectric element 41 extends in one direction by receiving predetermined voltage. That is, the piezoelectric element 41 is stretchable in the one direction. The piezoelectric element 41 deforms the diaphragm 35 in the thickness direction by expanding and contracting in the one direction. Driving force for deforming the diaphragm 35 in the thickness direction may be generated by another driving element such as a magnetostrictive element.

The piezoelectric element 41 of the present example embodiment has a rectangular parallelepiped shape that is long in the one direction. Although not particularly illustrated, the piezoelectric element 41 of the present example embodiment is formed by electrically connecting multiple piezoelectric bodies 41a made of piezoelectric ceramics such as lead zirconate titanate (PZT), being laminated in the one direction. That is, the piezoelectric element 41 includes the multiple piezoelectric bodies 41a laminated in the one direction. This enables increasing the amount of expansion and contraction of the piezoelectric element 41 in the one direction as compared with the piezoelectric element 41 including one piezoelectric body. The shape of a piezoelectric element is not limited to a rectangular parallelepiped shape, and another shape such as a columnar shape may be used.

The multiple piezoelectric bodies 41a are electrically connected by side electrodes (not illustrated) located opposite to each other in a direction intersecting the one direction. Thus, the piezoelectric element 41 extends in the one direction when the side electrodes receive predetermined voltage. The predetermined voltage applied to the piezoelectric element 41 is a drive signal received from the controller 60 described later.

The structure of the piezoelectric element 41 is similar to that of a conventional piezoelectric element, so that detailed description thereof will be eliminated. The piezoelectric element 41 may have only one piezoelectric body.

The plunger 44 is a rod-shaped member. The plunger 44 has one end in its axial direction, being in contact with the diaphragm 35. The plunger 44 has the other end in the axial direction, being in contact with the first base 42 described later, the first base 42 covering an end of the piezoelectric element 41 in the one direction. That is, the one direction of the piezoelectric element 41 aligns with the axial direction of the plunger 44. The plunger 44 is located between the piezoelectric element 41 and the diaphragm 35. This allows expansion and contraction of the piezoelectric element 41 to be transmitted to the diaphragm 35 via the plunger 44. The plunger 44 is a rod-shaped transmission member.

The other end of the plunger 44 is in a hemispherical shape. That is, the plunger 44 has a leading end close to the piezoelectric element 41, being in a hemispherical shape. This enables the expansion and contraction of the piezoelectric element 41 to be reliably transmitted by the diaphragm 35 via the plunger 44.

The piezoelectric element 41 has an end close to the diaphragm 35 in the one direction, the end being covered with the first base 42. The first base 42 is in contact with the plunger 44. The piezoelectric element 41 has an end opposite to the diaphragm 35 in the one direction, the end being covered with the second base 43. The second base 43 is supported by a fixed casing bottom-wall portion 47a of a fixed casing 47 described later.

The first base 42 and the second base 43 include bottom portions 42a and 43a, and vertical wall portions 42b and 43b located on their outer peripheral sides, respectively. The bottom portions 42a and 43a each have a size covering corresponding one of end surfaces of the piezoelectric element 41 in the one direction. The vertical wall portions 42b and 43b are each located covering a part of a side surface of the piezoelectric element 41.

The first base 42 and the second base 43 are each made of a wear-resistant material. At least one of the first base 42 and the second base 43 may be made of a sintered material in order to improve wear resistance. The first base 42 and the second base 43 may be different in hardness from each other.

The piezoelectric element 41 is housed in the casing 46. The casing 46 includes the fixed casing 47 and a pressurized casing 48. The pressurized casing 48 is housed in the fixed casing 47. The piezoelectric element 41 is housed in the pressurized casing 48. The fixed casing 47 and the pressurized casing 48 are fixed with bolts or the like (not illustrated).

The fixed casing 47 has a box shape opening toward the diaphragm 35. Specifically, the fixed casing 47 includes a fixed casing bottom-wall portion 47a and a fixed casing side-wall portion 47b.

The fixed casing bottom-wall portion 47a is located opposite to the diaphragm 35 across the piezoelectric element 41. The fixed casing bottom-wall portion 47a includes a hemispherical protrusion 47c that supports one of the ends of the piezoelectric element 41 in the one direction. That is, the liquid coating apparatus 1 incudes the hemispherical protrusion 47c protruding from the fixed casing bottom-wall portion 47a toward the piezoelectric element 41 in the one direction and supporting the end of the piezoelectric element 41 opposite to the diaphragm 35. This enables the end of the piezoelectric element 41 opposite to the diaphragm 35 to be supported by the protrusion 47c of the fixed casing bottom-wall portion 47a without partial contact. Thus, the end of the piezoelectric element 41 opposite to the diaphragm 35 can be more reliably supported by the fixed casing bottom-wall portion 47a.

The second base 43 is located between the piezoelectric element 41 and the protrusion 47c. That is, the liquid coating apparatus 1 includes the second base 43 between the piezoelectric element 41 and the protrusion 47c. This enables the end of the piezoelectric element 41 opposite to the diaphragm 35 to be reliably supported by the protrusion 47c with the second base 43 interposed therebetween while the end of the piezoelectric element 41 opposite to the diaphragm 35 is held by the second base 43.

The pressurized casing 48 has a box shape opening toward a side opposite to the diaphragm 35 across the piezoelectric element 41. Thus, in a state where the pressurized casing 48 is housed in the fixed casing 47, a part of the fixed casing bottom-wall portion 47a is exposed in the casing 46. The protrusion 47c described above is located in the exposed part of the fixed casing bottom-wall portion 47a.

The pressurized casing 48 includes a pressurized casing bottom-wall portion 48a and a pressurized casing side-wall portion 48b.

The pressurized casing bottom-wall portion 48a is located close to the diaphragm 35. The pressurized casing bottom-wall portion 48a includes a through-hole allowing the plunger 44 to pass therethrough. Thus, the plunger 44 extends in the one direction between the piezoelectric element 41 and the diaphragm 35, and passes through the pressurized casing bottom-wall portion 48a, thereby transmitting expansion and contraction of the piezoelectric element 41 to the diaphragm 35.

The pressurized casing bottom-wall portion 48a is supported on an upper surface of the base member 32. This does not allow force generated by the coil spring 45 described later and sandwiched between the pressurized casing bottom-wall portion 48a and the first base 42 to act on the diaphragm 35 supported by the base member 32, or allows the force even to act on the diaphragm 35 slightly.

The coil spring 45 described later is held between the pressurized casing bottom-wall portion 48a and the first base 42.

The pressurized casing side-wall portion 48b has an outer surface in contact with an inner surface of the fixed casing side-wall portion 47b, and the pressurized casing side-wall portion 48b has an inner surface in contact with the vertical wall portions 42b and 43b of the first base 42 and second base 43, respectively. This enables the first base 42 and the second base 43 to be held by the pressurized casing side-wall portion 48b. Thus, even when predetermined voltage is applied to the piezoelectric element 41, deformation of the piezoelectric element 41 in a direction orthogonal to the one direction is reduced.

The above structure allows the piezoelectric element 41 to be sandwiched between the plunger 44 and the protrusion 47c of the fixed casing bottom-wall portion 47a in the one direction. This enables expansion and contraction of the piezoelectric element 41 to be transmitted to the diaphragm 35 with the plunger 44 when the piezoelectric element 41 expands and contracts in the one direction. Thus, the diaphragm 35 can be deformed in its thickness direction by the expansion and contraction of the piezoelectric element 41. FIG. 2 illustrates movement of the plunger 44 due to the expansion and contraction of the piezoelectric element 41 in the one direction with a solid arrow.

The coil spring 45 is a spring member that spirally extends along the axis in the one direction. The coil spring 45 is sandwiched in the one direction between the first base 42 and the pressurized casing bottom-wall portion 48a. The plunger 44 in a rod-like shape passes through inside the coil spring 45 in the axial direction. That is, the first base 42 is located between the piezoelectric element 41 and the plunger 44 together with the coil spring 45. The coil spring 45 extends along the axis of the plunger 44 between the piezoelectric element 41 and the pressurized casing bottom-wall portion 48a.

This allows the coil spring 45 to apply force to compress the piezoelectric element 41 in the one direction via the first base 42. FIG. 2 illustrates compressive force of the coil spring 45 with a white arrow. The compressive force generated by the coil spring 45 preferably allows the first base 42 to be located in contact with the plunger 44 in a state where no voltage is applied to the piezoelectric element 41. For example, the compressive force is preferably 30 to 50% of force generated in the piezoelectric element 41 when rated voltage is applied to the piezoelectric element 41.

When the first base 42 is located between the piezoelectric element 41 and the plunger 44 together with the coil spring 45, the expansion and contraction of the piezoelectric element 41 can be stably transmitted to the plunger 44 via the first base 42. At the same time, the compressive force of the coil spring 45 can be stably transmitted to the piezoelectric element 41 via the first base 42.

Here, when the liquid has a high viscosity, the piezoelectric element 41 is required to operate at high speed. Thus, it is conceivable to improve responsiveness of the piezoelectric element 41 by inputting a drive signal with a rectangular wave to the piezoelectric element 41. In this case, when the piezoelectric element 41 expands and contracts at high speed, the piezoelectric element 41 may expand and contract excessively, causing internal damage such as peeling. In particular, when the piezoelectric element 41 has multiple piezoelectric bodies 41a laminated in an expansion-contraction direction, high-speed operation of the piezoelectric element 41 tends to cause damage such as peeling inside the piezoelectric element 41. The excessive expansion and contraction of the piezoelectric element 41 means that the amount of expansion and contraction of the piezoelectric element 41 is larger than the maximum amount of expansion and contraction when the rated voltage is applied to the piezoelectric element 41.

In contrast, when the piezoelectric element 41 is compressed in the one direction by the coil spring 45 as in the present example embodiment, damage such as peeling due to expansion and contraction of the piezoelectric element 41 can be prevented from occurring inside the piezoelectric element 41 even when the piezoelectric element 41 receives a drive signal with a rectangular wave. That is, the coil spring 45 can suppress excessive expansion and contraction of the piezoelectric element 41, and can prevent occurrence of internal damage of the piezoelectric element 41 due to its expansion and contraction. This enables improving durability of the piezoelectric element 41.

When the coil spring 45 is located between the piezoelectric element 41 and the pressurized casing bottom-wall portion 48a as described above, the pressurized casing bottom-wall portion 48a can receive elastic restoring force of the coil spring 45. Thus, the diaphragm 35 can be prevented from being deformed by the elastic restoring force of the coil spring 45. This enables preventing a liquid from leaking from the discharge port 32a and liquid discharge performance from being deteriorated.

When the plunger 44 passes through inside the coil spring 45 spirally extending along the axis in the axial direction, the plunger 44 and the coil spring 45 can be compactly disposed. This enables the liquid coating apparatus 1 to be miniaturized.

Next, a configuration of the controller 60 will be described below.

The controller 60 controls drive of the liquid coating apparatus 1. That is, the controller 60 controls drive of each of the pressure adjusting unit 20 and the drive 40.

The controller 60 includes a pressure adjustment controller 61 and a drive controller 62.

The pressure adjustment controller 61 outputs a control signal to the first switching valve 23 and the second switching valve 24 of the pressure adjusting unit 20. The pressure adjustment controller 61 also outputs a positive pressure pump drive signal to the positive pressure pump 21a. The pressure adjustment controller 61 further outputs a negative pressure pump drive signal to the negative pressure pump 22a. The pressure adjustment controller 61 outputs the control signal to the first switching valve 23 and the second switching valve 24 to control pressure in the liquid storage assembly 10.

For example, when positive pressure is applied to the liquid storage assembly 10, the pressure adjustment controller 61 outputs a first control signal for connecting the positive pressure generator 21 to the liquid storage assembly 10 to the first switching valve 23. When negative pressure is applied to the liquid storage assembly 10, the pressure adjustment controller 61 outputs a second control signal for connecting the second switching valve 24 to the liquid storage assembly 10 to the first switching valve 23, and outputs a third control signal for connecting the negative pressure generator 22 to the first switching valve 23 to the second switching valve 24. When pressure inside the liquid storage assembly 10 is set to the atmospheric pressure, the pressure adjustment controller 61 outputs the second control signal for connecting the second switching valve 24 to the liquid storage assembly 10 to the first switching valve 23, and outputs a fourth control signal for connecting the atmospheric opening unit 25 to the first switching valve 23 to the second switching valve 24.

The pressure adjustment controller 61 controls drive of the negative pressure pump 22a in response to a pressure signal output from the pressure sensor 26. That is, when driving the negative pressure pump 22a does not allow pressure detected by the pressure sensor 26 to reach the negative pressure target value, the pressure adjustment controller 61 sets the negative pressure target value lower and causes the negative pressure pump 22a to be driven in accordance with a new negative pressure target value. In this way, when decrease in the remaining amount of liquid in the liquid storage assembly 10 is detected by the pressure sensor 26 as high negative pressure in the liquid storage assembly 10, the pressure adjustment controller 61 sets the negative pressure target value lower to bring negative pressure generated by the negative pressure pump 22a close to the atmospheric pressure. That is, the pressure adjustment controller 61 brings the negative pressure generated by the negative pressure pump 22a close to the atmospheric pressure when the pressure sensor 26 detects decrease in the remaining amount of liquid in the liquid storage assembly 10.

This enables the pressure in the liquid storage assembly 10 to be set to appropriate negative pressure in accordance with the remaining amount of liquid in the liquid storage assembly 10. That is, when a large amount of liquid remains in the liquid storage assembly 10 and the negative pressure in the liquid storage assembly 10 is too low, the liquid may leak from the discharge assembly 30. In contrast, when a small amount of liquid remains in the liquid storage assembly 10 and the negative pressure in the liquid storage assembly 10 is too high, air may enter the liquid chamber 33. For this subject, the above configuration enables the pressure in the liquid storage assembly 10 to be set to appropriate negative pressure that prevents the liquid from leaking from the discharge assembly 30 and air from entering the liquid chamber 33.

The pressure adjustment controller 61 also controls drive of the positive pressure pump 21a. The drive of the positive pressure pump 21a is similar to that of a conventional configuration, so that detailed description thereof will be eliminated.

The drive controller 62 controls drive of the piezoelectric element 41. That is, the drive controller 62 outputs a drive signal to the piezoelectric element 41. This drive signal includes a discharge signal.

The discharge signal allows the piezoelectric element 41 to expand and contract to vibrate the diaphragm 35 as described later, thereby discharging the liquid in the liquid chamber 33 to the outside through the discharge port 32a.

The controller 60 controls timing of allowing the drive controller 62 to output the discharge signal to the piezoelectric element 41 and timing of outputting the control signals to the pressure adjusting unit 20.

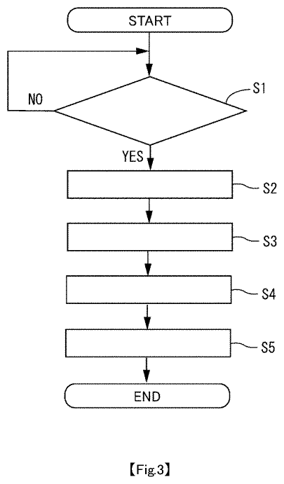

FIG. 3 is a flowchart illustrating an example of operation of discharging a liquid with the discharge assembly 30 and adjusting pressure in the liquid storage assembly 10 with the pressure adjusting unit 20. Control of the timing of allowing the drive controller 62 to output the discharge signal to the piezoelectric element 41 and the timing of outputting the control signals to the pressure adjusting unit 20, the control being performed by the controller 60, will be described.

As illustrated in FIG. 3, the controller 60 first determines whether an external signal instructing discharge is received (step S1). This external signal is received by the controller 60 from a controller or the like higher than the controller 60.

When the controller 60 receives an external signal (YES in step S1), in step S2, the pressure adjustment controller 61 of the controller 60 generates the first control signal for connecting the positive pressure generator 21 to the liquid storage assembly 10 in the first switching valve 23 of the pressure adjusting unit 20 and outputs it to the first switching valve 23. The first switching valve 23 is driven in response to the first control signal. This causes the inside of the liquid storage assembly 10 to be pressurized to positive pressure. In contrast, when the controller 60 receives no external signal (NO in step S1), the determination in step S1 is repeated until the controller 60 receives an external signal.

After step S2, the drive controller 62 of the controller 60 outputs a discharge signal to the piezoelectric element 41 to discharge the liquid to the discharge assembly 30 through the discharge port 32a (step S3).

After the drive controller 62 outputs the discharge signal to the piezoelectric element 41, the pressure adjustment controller 61 may output the first control signal to the first switching valve 23. That is, discharge of the discharge assembly 30 may be performed before pressurization of positive pressure in the liquid storage assembly 10.

After that, the pressure adjustment controller 61 generates the second control signal for connecting the second switching valve 24 to the liquid storage assembly 10 in the first switching valve 23 of the pressure adjusting unit 20, and outputs it to the first switching valve 23. The pressure adjustment controller 61 also generates the third control signal for connecting the atmospheric opening unit 25 to the first switching valve 23 in the second switching valve 24, and outputs it to the second switching valve 24 (step S4). The first switching valve 23 is driven in response to the second control signal. The second switching valve 24 is driven in response to the third control signal. This causes the pressure in the liquid storage assembly 10 to be the atmospheric pressure.

Subsequently, the pressure adjustment controller 61 generates the fourth control signal for connecting the negative pressure generator 22 to the first switching valve 23 in the second switching valve 24, and outputs it to the second switching valve 24 (step S5). The second switching valve 24 is driven in response to the fourth control signal. This causes the pressure in the liquid storage assembly 10 to be negative pressure. Thus, the liquid can be prevented from leaking through the discharge port 32a of the discharge assembly 30. Then, this flow is ended (END). The controller 60 repeatedly performs the above-mentioned flow as necessary.

When the pressure in the liquid storage assembly 10 is controlled as described above, the liquid can be stably discharged through the discharge port 32a at appropriate timing without leakage of the liquid through the discharge port 32a of the discharge assembly 30.

The liquid coating apparatus 1 of the present example embodiment includes the liquid storage assembly 10 to store a liquid, the pressure sensor 26 that detects a remaining amount of liquid in the liquid storage assembly 10, the discharge assembly 30 that discharges the liquid in the liquid storage assembly 10 to the outside, the negative pressure pump 22a that generates negative pressure lower than atmospheric pressure, the negative pressure adjusting container 22b with internal pressure adjusted to predetermined negative pressure by the negative pressure pump 22a, the pressure adjustment controller 61 that controls drive of the negative pressure pump 22a based on a detection result of the pressure sensor 26, and the pressure switching assembly 50 that is structured to adjust pressure in the liquid storage assembly 10 to the predetermined negative pressure in the negative pressure adjusting container 22b.

This causes the negative pressure generated by the negative pressure pump 22a to be uniformed in the negative pressure adjusting container 22b. Thus, the pressure switching assembly 50 can quickly switch the pressure in the liquid storage assembly 10 to the predetermined negative pressure in the negative pressure adjusting container 22b. Additionally, pulsation when the negative pressure pump 22a generates negative pressure can also be reduced by the negative pressure adjusting container 22b. This enables the pressure in the liquid storage assembly 10 to be quickly set to the predetermined negative pressure.

The above configuration also enables the negative pressure in the liquid storage assembly 10 to be adjusted in accordance with the remaining amount of liquid in the liquid storage assembly 10. When a large amount of liquid remains in the liquid storage assembly 10 and the negative pressure in the liquid storage assembly 10 is too low, the liquid may leak from the discharge assembly 30. In contrast, when a small amount of liquid remains in the liquid storage assembly 10, for example, and the negative pressure in the liquid storage assembly 10 is too high, air may enter the liquid chamber 33. For this subject, the above configuration enables the pressure in the liquid storage assembly 10 to be set to appropriate negative pressure that prevents the liquid from leaking from the discharge assembly 30 and air from entering the liquid chamber 33.

The above configuration allows the liquid coating apparatus 1 to include the negative pressure adjusting container 22b, so that the pressure in the liquid storage assembly 10 can be brought close to the predetermined negative pressure without exceeding the predetermined negative pressure due to a ratio of volume of the negative pressure adjusting container 22b to volume of a flow path connected to the negative pressure adjusting container 22b. That is, the negative pressure adjusting container 22b also has a function of preventing negative pressure to be supplied to the liquid storage assembly 10 from exceeding the predetermined negative pressure.

In the present example embodiment, the liquid coating apparatus 1 further includes the positive pressure generator 21 that generates positive pressure higher than the atmospheric pressure. The pressure switching assembly 50 switches the pressure in the liquid storage assembly 10 among the positive pressure generated by the positive pressure generator 21, the predetermined negative pressure in the negative pressure adjusting container 22b, and the atmospheric pressure.

This enables the pressure in the liquid storage assembly 10 to be switched between the positive pressure for supplying the liquid from the liquid storage assembly 10 to the discharge assembly 30 and the negative pressure for preventing the liquid from leaking from the discharge assembly 30. Thus, the liquid can be stably discharged from the discharge assembly 30, and the liquid can be prevented from leaking from the discharge assembly 30 when the liquid is not discharged from the discharge assembly 30.

When the negative pressure generator 22 includes the negative pressure adjusting container 22b as in the present example embodiment, the pressure in the liquid storage assembly 10 can be quickly and stably set to the predetermined negative pressure when the pressure in the liquid storage assembly 10 is switched to the negative pressure as described above.

In the present example embodiment, the discharge assembly 30 includes the liquid chamber 33 to which a liquid is supplied, the inflow path 34 that is connected to the liquid chamber 33 and allows the liquid to be supplied from the liquid storage assembly 10 into the liquid chamber 33, the diaphragm 35 that constitutes a part of the wall portion defining the liquid chamber 33, and is deformed to change volume of the liquid chamber 33, and the drive 40 that deforms the diaphragm 35 in its thickness direction.

The discharge assembly 30 configured as described above requires high accuracy in discharge rate and discharge timing because the discharge assembly 30 is configured to discharge a minute amount of liquid. This requires the discharge assembly 30 configured as described above to control negative pressure in the liquid storage assembly 10 with higher accuracy. When the liquid coating apparatus 1 including the discharge assembly 30 described above is provided with the negative pressure generator 22 having the negative pressure adjusting container 22b as in the present example embodiment, the pressure in the liquid storage assembly 10 can be quickly and stably set to the predetermined negative pressure. Thus, the configuration of the present example embodiment is more effective for the liquid coating apparatus 1 including the discharge assembly 30 configured as described above.

Although the example embodiment of the present disclosure is described above, the above-described example embodiment is merely an example for implementing the present disclosure. Thus, the above-described example embodiment can be appropriately modified and implemented within a range without departing from the gist thereof and being limited to the above-described example embodiment.

In the above example embodiment, the liquid coating apparatus 1 is a so-called ink-jet liquid coating apparatus that discharges a liquid in the liquid chamber 33 to the outside by deforming the diaphragm 35 in its thickness direction to change volume of the liquid chamber 33. However, the liquid coating apparatus may be a so-called nozzle-type liquid coating apparatus that discharges a liquid from a nozzle using a pressure change in the liquid chamber. The configuration of the discharge assembly of the liquid coating apparatus is not limited to the configuration of the present example embodiment as long as a liquid in the liquid chamber 33 can be discharged to the outside using deformation of a diaphragm in its thickness direction.

In the above example embodiment, the positive pressure generator is the positive pressure pump 21a, and the negative pressure generator is the negative pressure pump 22a. However, the positive pressure generator may have a configuration other than a pump as long as it can generate positive pressure. The negative pressure generator may have a configuration other than a pump as long as it can generate negative pressure.

In the above example embodiment, the pressure adjusting unit 20 includes the first switching valve 23 that is connected to the liquid storage assembly 10 by switching between a line connected to the positive pressure generator 21 and a line connected to the second switching valve 24, and the second switching valve 24 that is connected to the first switching valve 23 by switching between a line connected to the negative pressure generator 22 and a line connected to the atmospheric opening unit 25.

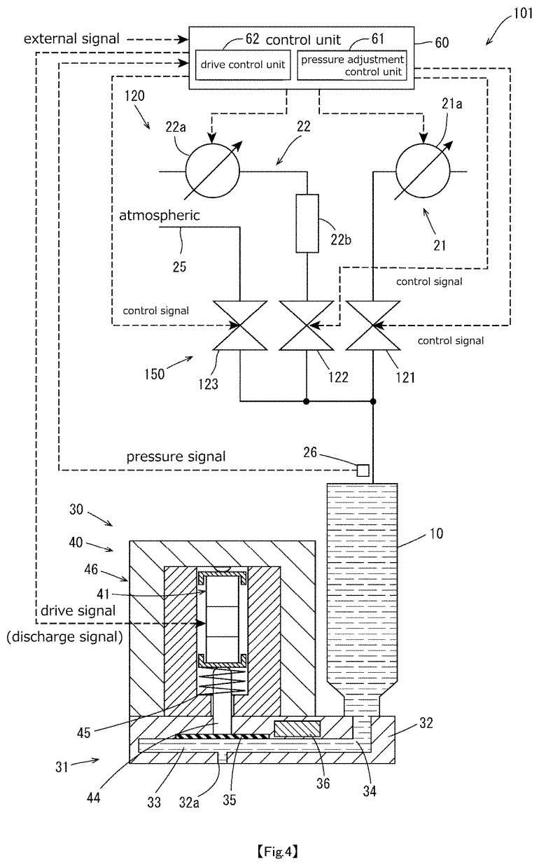

However, as illustrated in FIG. 4, a pressure adjusting unit 120 of a liquid coating apparatus 101 may include a pressure switching assembly 150 that connects each of the positive pressure generator 21, the negative pressure generator 22, and the atmospheric opening unit 25 to the liquid storage assembly 10. In FIG. 4, the same components as those in FIG. 1 are designated by the same reference numerals, and description thereof is eliminated.

The pressure switching assembly 150 includes a positive pressure switching valve 121, a negative pressure switching valve 122, and an atmospheric pressure switching valve 123. The positive pressure switching valve 121 is located between the positive pressure generator 21 and the liquid storage assembly 10. The negative pressure switching valve 122 is located between the negative pressure generator 22 and the liquid storage assembly 10. The atmospheric pressure switching valve 123 is located between an atmospheric opening unit 125 and the liquid storage assembly 10. The negative pressure adjusting container 22b of the negative pressure generator 22 is located between the negative pressure pump 22a and the negative pressure switching valve 122. The positive pressure switching valve 121, the negative pressure switching valve 122, and the atmospheric pressure switching valve 123 can be each opened and closed in response to a control signal received from the controller 60.

The positive pressure switching valve 121 is opened to connect the positive pressure generator 21 to the liquid storage assembly 10 when pressure in the liquid storage assembly 10 is set to positive pressure, while being closed in other cases. The negative pressure switching valve 122 is opened to connect the negative pressure generator 22 to the liquid storage assembly 10 when the inside of the liquid storage assembly 10 is set to negative pressure, while being closed in other cases. The atmospheric pressure switching valve 123 is opened to connect the atmospheric opening unit 25 to the liquid storage assembly 10 when the inside of the liquid storage assembly 10 is set to the atmospheric pressure, while being closed in other cases.

Even the liquid coating apparatus 101 configured as described above enables the pressure switching assembly 150 to switch the pressure in the liquid storage assembly 10 among the positive pressure generated by the positive pressure generator 21, the predetermined negative pressure in the negative pressure adjusting container 22b, and the atmospheric pressure. When the liquid coating apparatus 101 described above also includes the negative pressure adjusting container 22b similar to that in the example embodiment, pressure in the liquid storage assembly 10 can be quickly set to the predetermined negative pressure. Thus, even the configuration of the liquid coating apparatus 101 enables acquiring an operation effect similar to that of the configuration of the above example embodiment.

The pressure adjusting unit is not limited to the configuration illustrated in each of FIGS. 1 and 4, and may have any configuration as long as the positive pressure generator, the negative pressure generator, and the atmospheric opening unit can be each connected to the liquid storage assembly.

In the above example embodiment, the liquid coating apparatus 1 detects the remaining amount of liquid in the liquid storage assembly 10 as pressure in the liquid storage assembly 10 with the pressure sensor 26. However, the liquid coating apparatus may detect the remaining amount of liquid in a liquid remaining unit with another configuration.

In the above example embodiment, the liquid storage assembly 10 can be connected to the atmospheric opening unit by the pressure adjusting unit 20. However, the pressure adjusting unit may have a configuration in which the atmospheric opening unit cannot be connected to the liquid storage assembly. The pressure adjusting unit may have any configuration as long as pressure in the liquid storage assembly can be set to the predetermined negative pressure in the negative pressure adjusting container.

In the above example embodiment, the liquid storage assembly 10 can be connected to the positive pressure generator 21 by the pressure adjusting unit 20. However, the liquid coating apparatus may not include a positive pressure generator. That is, the liquid coating apparatus may control pressure in the liquid storage assembly using negative pressure and the atmospheric pressure.

In the example embodiment, the coil spring 45 compresses the piezoelectric element 41 in one direction. However, when the piezoelectric element can be compressed in one direction, the piezoelectric element may be compressed by a configuration other than a coil spring. That is, although in the above example embodiment, the coil spring 45, which is a spiral spring member, is described as an example of a compressive force applying unit, besides this, the spiral spring member may be, for example, a so-called coiled wave spring in which a wire rod or a flat plate, having a predetermined length and a wavy shape, is spirally wound. The compressive force applying unit may have a structure other than the spiral shape as long as the piezoelectric element can be compressed in one direction. The compressive force applying unit is preferably disposed preventing interference with the plunger regardless of structure.

The present disclosure is available for a liquid coating apparatus that discharges a liquid from a discharge assembly, for example.

Features of the above-described preferred example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-6. (canceled)

7. A liquid coating apparatus, comprising:
a liquid storage assembly to store a liquid;
a liquid remaining amount detector to detect a remaining amount of liquid in the liquid storage assembly;
a discharge assembly to discharge the liquid in the liquid storage assembly to an outside;
a negative pressure generator to generate a negative pressure lower than an atmospheric pressure;
a negative pressure adjusting container with an internal pressure adjusted to a predetermined negative pressure by the negative pressure generator;
a pressure adjustment controller to control drive of the negative pressure generator based on a detection result of the liquid remaining amount detector; and
a pressure switch to adjust a pressure in the liquid storage assembly to the predetermined negative pressure in the negative pressure adjusting container.

8. The liquid coating apparatus according to claim 7, further comprising:
a positive pressure generator to generate positive pressure that is higher than the atmospheric pressure; wherein
the pressure switch is configured or programmed to switch the pressure in the liquid storage assembly between the positive pressure generated by the positive pressure generator, the predetermined negative pressure in the negative pressure adjusting container, and the atmospheric pressure.

9. The liquid coating apparatus according to claim 7, wherein the pressure adjustment controller is configured or programmed to bring a negative pressure generated by the negative pressure generator close to the atmospheric pressure when the liquid remaining amount detector detects a decrease in the remaining amount of liquid in the liquid storage assembly.

10. The liquid coating apparatus according to claim 7, wherein the liquid remaining amount detector is configured or programmed to detect the remaining amount of liquid in the liquid storage assembly based on the pressure in the liquid storage assembly.

11. The liquid coating apparatus according to claim 8, wherein the pressure switch includes a first pressure switch to switch the pressure in the liquid storage assembly between the positive pressure generated by the positive pressure generator and a pressure other than the positive pressure, and a second pressure switch to switch between the atmospheric pressure and the predetermined negative pressure in the negative pressure adjusting container as the pressure other than the positive pressure.

12. The liquid coating apparatus according to claim 7, wherein the discharge assembly includes a liquid chamber to which the liquid is supplied, an inflow path that is connected to the liquid chamber to allow the liquid to be supplied from the liquid storage assembly into the liquid chamber, a diaphragm that includes a portion of a wall portion defining the liquid chamber and is deformable to change a volume of the liquid chamber, and a driver to deform the diaphragm in its thickness direction.
